(19) United States
(12) Patent Application Publication
(10) Pub. No.: US 2006/0126913 A1
(43) Pub. Date: Jun. 15, 2006

(54) Bill discriminating device

(76) Inventors: Nobuyuki Iida, Sakado-shi (JP); Noboru Yamagishi, Sakado-shi (JP); Yukio Ito, Sakado-shi (JP)

Correspondence Address: ERIC ROBINSON, PMB 955, 21010 SOUTHBANK ST., POTOMAC FALLS, VA, 20165, US

(21) Appl. No.: 11/298,940

(22) Filed: Dec. 12, 2005

(30) Foreign Application Priority Data
Dec. 13, 2004 (JP) 2004-359808

(51) Int. Cl. G06K 9/00

(52) U.S. Cl. 382/135

(57) ABSTRACT

The bill discriminating device comprises: a bill discriminating portion (2) that discriminates inserted bills; a bill accommodating portion (7) that accommodates bills determined as effective and includes a lift member (4) that aligns and presses the effective bills; and a body (1) to which the bill discriminating portion (2) and the bill accommodating portion (7) are mounted, wherein the device further includes: a first switch portion (5) mounted to the bill discriminating portion (2) and having an electrical function; and a second switch portion (4a) placed on the lift member (4) and having no electrical function, the first switch portion (5) and the second switch portion (4a) are combined to constitute one switch means when the bill discriminating portion (2) is mounted to the body (1) and the lift member (4) is placed in a predetermined position, and one switch means generates a first output signal.

### BACKGROUND OF THE INVENTION

1. Field of the Invention

The present invention relates to a bill discriminating device that can use one sensor to detect that a lift member that compresses bundles of bills is placed in a home position in a bill accommodating portion, and detect that a bill discriminating portion is removed from a body of the bill discriminating device.

2. Related Background Art

A general bill discriminating device used in a vending machine determines the effectiveness of bills, and accumulates bills determined as effective (true) only in a bill accommodating portion. At this time, a pressure plate that aligns and presses the bundles of bills is used to compress the bundles of bills and thus accumulate the bills in the bill accommodating portion. If the bill accommodating portion is full of bills, the pressure plate cannot be operated and more bills cannot be accumulated, and thus it is necessary to detect that the bill accommodating portion is full of bills using any method. One method is to detect the position of the pressure plate to detect whether the bill accommodating portion in which the bills are accumulated is full.

For example, Japanese Patent Application Laid-Open No. H9-16829 discloses that a motor is driven to expand and contract a pantograph-shaped member to drive a pressure plate connected to one end of the pantograph-shaped member. In this bill discriminating device, a rack that is moved in accordance with the rotation of a shaft of the motor is provided in a bill accommodating portion, and a detection member provided in a bill discriminating portion detects the movement to detect that the pressure plate is placed in a predetermined position. The rack is adapted to be moved in accordance with the rotation of the shaft of the motor by a plurality of gears and a pinion, and thus when incomplete engagement between the plurality of gears and part of the pinion prevents alignment between a predetermined position of the rack and a predetermined position of the pressure plate, false detection of the position of the pressure plate may be made.

Japanese Utility Model Application Laid-Open No. H2-93124 also discloses a configuration for detecting that a pressure plate is placed in a predetermined position. Specifically, a return position detection sensor provided in a bill accommodating portion detects whether the pressure plate of a pressing device is placed in a predetermined return position. When a signal from the return position detection sensor indicates that the pressure plate is not placed in the predetermined return position, a motor is rotated in a reverse direction to return the pressure plate to the predetermined return position. With the above described configuration for detecting whether the pressure plate is placed in the predetermined return position independently of the rotation of the motor, false detection of the position of the pressure plate can be avoided even if idling of the motor or the like prevents accurate correspondence between the rotation of the motor and the position of the pressure plate. In the above described configuration, however, the sensor means is provided in the bill accommodating portion, and thus electronic elements are placed over a bill discriminating portion and the bill accommodating portion, and separate substrates need to be provided. Generally, electronic elements are extremely sensitive to external environment, in particular, ambient temperature or humidity caused by rainfall, or the like, and need to be sealed for eliminating the influence of such environment. Thus, it is not preferable in view of sealing that the plurality of substrates are provided physically separately. Further, the plurality of substrates need to be placed physically separately, thereby increasing complexity of a production process and production costs.

Further, in the bill discriminating device, when the bill accommodating portion is full of bills, the accumulated bills are taken out, and at the same time, maintenance of the bill discriminating portion is generally performed. For the maintenance, the bill discriminating portion needs to be removed from a body of the bill discriminating device. In such a case, it is convenient that the removal of the bill discriminating portion from the body of the bill discriminating device is detected. For example, Japanese Patent Application Laid-Open No. 2003-22463 discloses a bill discriminating device that uses sensor means to detect a slight opening of a bill discriminating portion with respect to a body of the bill discriminating device. Specifically, in the bill discriminating portion, a disk with a slit that is moved in accordance with the rotation of a motor for conveying bills is placed, and detection means including a light emitting element and a light receiving element in pair is placed below the disk so as to hold the disk therebetween. The detection means and the disk with the slit cooperate and function as one sensor means. When the detection means alternately detects blocking and receiving of light at predetermined intervals, the bill discriminating portion is closed with respect to the body of the bill discriminating device, and when the detection means detects the receiving of the light only, the bill discriminating portion is opened with respect to the body of the bill discriminating device. In this manner, the opening and closing of the bill discriminating portion can be detected. However, the sensor means cannot detect that a pressure plate is placed in a predetermined position, and thus separate sensor means needs to be provided. Thus, the above described bill discriminating device encounters inconvenience in sealing of electronic elements and an increase in production costs caused by increased complexity of a production process.

### SUMMARY OF THE INVENTION

An object of the present invention is to solve the problems in the related art. Specifically, a first object is to provide a bill discriminating device that can use one detection means only provided in a bill discriminating portion to detect that a lift member that compresses bundles of bills is placed in a home position in a bill accommodating portion, and detect that the bill discriminating portion is removed from a body of the bill discriminating device. A second object is to provide a bill discriminating device that can detect that a pressure plate is placed in a predetermined position independently of the rotation of a motor to prevent false detection of the position of the lift member caused by inaccurate engagement of gears or the like. A third object is to provide a bill discriminating device in which electronic elements such as sensor means are collectively placed in the bill discriminating portion to facilitate sealing of the electronic elements and significantly reduce production costs.

The present invention provides a bill discriminating device including: a bill discriminating portion that discriminates inserted bills; a bill accommodating portion that accommodates bills determined as effective and includes a lift member that aligns and presses the effective bills; and a body to which the bill discriminating portion and the bill accommodating portion are mounted, wherein the device further includes: a first switch portion mounted to the bill discriminating portion and having an electrical function; and a second switch portion placed on the lift member and having no electrical function, the first switch portion and the second switch portion are combined to constitute one switch means when the bill discriminating portion is mounted to the body and the lift member is placed in a predetermined position, and one switch means generates a first output signal.

In the bill discriminating device according to the present invention, when the lift member is not placed in the predetermined position with the bill discriminating portion being mounted to the body, or when the bill discriminating portion is removed from the body with the lift member being placed in the predetermined position, one switch means generates a second output signal.

With such a configuration, one detection means only provided in the bill discriminating portion can be used to detect that the lift member that compresses bundles of bills is placed in a home position in the bill accommodating portion, and detect that the bill discriminating portion is removed from the body of the bill discriminating device. Further, such an event can be prevented that the detection means determines that the lift member is moved even when the lift member is not actually moved because of inaccurate engagement of gears or the like though the motor rotates properly, and determines that the lift member is placed in the home position though not in the home position. Further, no detection means needs to be provided in the bill accommodating portion, thereby allowing substrates on which electronic components such as the detection means are placed to be collectively placed in the bill discriminating portion.

### BRIEF DESCRIPTION OF THE DRAWINGS

FIG. 1 shows a bill discriminating device according to the present invention when a lift member is placed in a home position, and a bill discriminating portion is mounted to a body of a bill discriminating device and in a normal operation state;

FIG. 2A is an enlarged view of a peripheral portion of detection means of the bill discriminating device according to the present invention;

FIG. 2B is an enlarged view of the peripheral portion of the detection means of the bill discriminating device according to the present invention;

FIG. 3 shows a state where the lift member placed in a bill accommodating portion is moved from the home position for pressing bills; and

FIG. 4 shows a state where the bill discriminating portion is removed from the body of the bill discriminating device with the lift member being placed in the home position.

### DESCRIPTION OF THE PREFERRED EMBODIMENTS

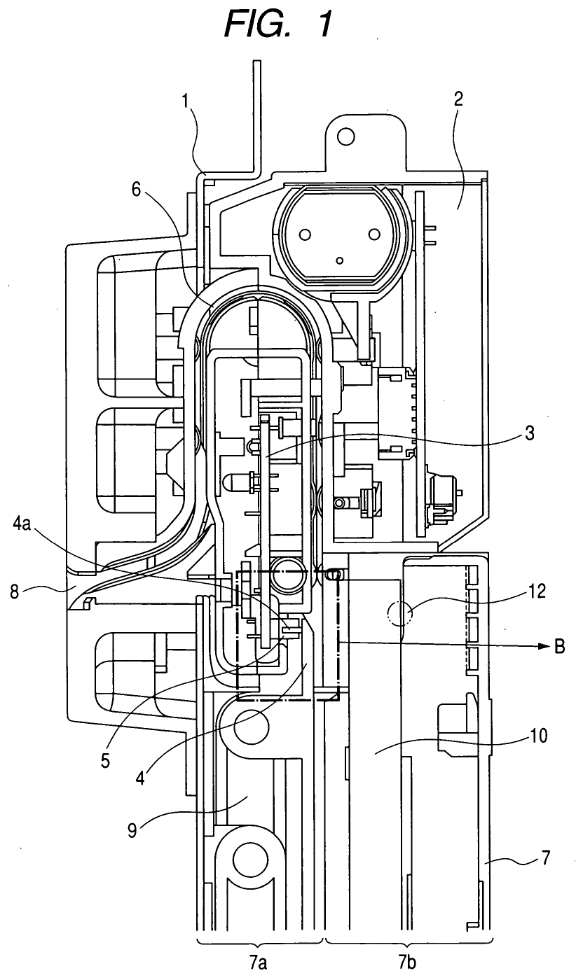

FIGS. 1 to 4 are sectional views of a bill discriminating device according to the present invention. The bill discriminating device includes a body 1, a bill discriminating portion 2, and a bill accommodating portion 7. The body 1 includes a bill insertion port 8 that is placed in a front surface of the body 1 and receives inserted bills. The bill discriminating portion 2 includes a bill conveying passage 6 that is connected to the bill insertion port 8 when the bill discriminating portion 2 is mounted to the body 1 and guides the bills to a stacker in the bill accommodating portion 7, and a bill discriminating sensor (not shown, hereinafter the same) that discriminates the bills conveyed through the bill conveying passage 6. The bill discriminating portion 2 is rotatably connected to the body 1 of the bill discriminating device by a rotation shaft 12 placed in parallel with a long side of the bill insertion port 8. The bill accommodating portion 7 is mounted below the bill discriminating portion 2 in the body 1 of the bill discriminating device. The bill accommodating portion 7 is parallel to front and rear surfaces of the bill discriminating device, and has a surface facing in parallel with a surface that constitutes part of the bill conveying passage 6 of the bill discriminating portion 2. The surface of the bill accommodating portion 7 parallel to the front and rear surfaces of the bill discriminating device and facing in parallel with the surface that constitutes part of the bill conveying passage 6 of the bill discriminating portion 2 constitutes part of the bill conveying passage 6 together with the surface that constitutes part of the bill conveying passage 6 of the bill discriminating portion 2 when the bill discriminating portion 2 is mounted to the body of the bill discriminating device. The bill accommodating portion 7 includes a lift member 4 that presses the bills guided by the stacker toward the rear surface of the bill discriminating device perpendicularly to the rear surface, and a drive portion 9 that includes a stack motor (not shown, hereinafter the same) and a pantograph-shaped member, and drives the stack motor to expand and contract the pantograph-shaped member and move the lift member. The bill accommodating portion 7 includes a case 7a that accommodates the drive portion 9, and a bill accommodating case 7b. The lift member 4 aligns the bills guided by the stacker in the bill accommodating portion 7 via the bill conveying passage 6 and accommodates the bills in the bill accommodating case 7b. The bill discriminating portion 2 includes detection means 5 that is placed on a surface below the surface that constitutes part of the bill conveying passage 6 of the bill discriminating portion 2 and parallel to the front and rear surfaces of the bill discriminating device. The detection means 5 is electrically connected to a main substrate 3. The lift member 4 has a surface facing the detection means 5 placed in the bill discriminating portion 2, and the surface has a rib 4a protruding from the lift member 4.

FIG. 1 shows the bill discriminating device according to the present invention in a state where the bill discriminating portion 2 is mounted to the body 1 of the bill discriminating device, and the lift member 4 is placed in a home position. The bill discriminating portion 2 is rotatably connected to the body 1 of the bill discriminating device by the shaft. In the state in FIG. 1, when a bill is inserted into the bill insertion port 8, a bill insertion sensor (not shown, hereinafter the same) detects the insertion of the bill. When the bill insertion sensor detects the insertion of the bill, the bill conveying passage 6 is driven to convey the bill. A conveying position detection sensor is provided along the bill conveying passage 6, and detects a conveying position of the bill. When the inserted bill passes through the conveying position detection sensor, the bill conveying passage 6 is blocked by a shutter member (not shown, hereinafter the same) so as to prevent the bill having passed through the sensor from going backward through the bill conveying passage 6. When the bill position detection sensor and the bill insertion sensor detect the bill in this order before the bill conveying passage is blocked by the shutter member, it is determined that the bill is improperly taken out, and the bill discriminating sensor outputs no true bill signal.

While the shutter member blocks the bill conveying passage 6, the bill discriminating sensor determines the effectiveness of the bill. The bill is discriminated using a magnetic sensor and an optical sensor together to determine whether the bill is true by pattern matching of the inserted bill. In this determination, the bill discriminating sensor determines a bill within a certain range as an effective bill. The bill discriminating portion 2 has a function of adjusting the range. For example, when the bill discriminating portion 2 is left after maintenance without being completely mounted to the body 1 of the bill discriminating device, exposure of light through a clearance or the like exerts an influence on sensitivity of the optical sensor. If the bill discriminating sensor determines whether the bill is true without the adjustment of the range in such a case, the bill discriminating sensor rejects a bill that should be determined as effective, or determines, as effective, a bill that should not be determined as effective. When the bill discriminating sensor determines that the inserted bill is not effective, the shutter portion opens the bill conveying passage, and the bill is passed backward through the bill conveying passage and returned to the bill insertion port. When the bill discriminating sensor determines that the inserted bill is effective, bill discriminating means (not shown, hereinafter the same) outputs a bill determining signal, and the bill is conveyed to the stacker in the body 1 of the bill discriminating device.

The bill accommodating portion 7 includes the case 7a that accommodates the lift member 4 and the drive portion 9 that drives the lift member 4, and the bill accommodating case 7b. A back plate 10 is placed on the bill accommodating case 7b, and urged by a spring or the like to press accommodated bundles of bills toward the lift member 4. The bills having passed through the bill discriminating portion 2 are guided by the stacker in the bill accommodating portion 7 via a slit between the bill discriminating portion 2 and the bill accommodating portion 7. The lift member 4 aligns the bundles of bills accommodated in the stacker and presses the bundles toward the back plate 10 so as to be accommodated in the bill accommodating case 7b. The lift member 4 is driven by the drive portion 9, but the drive portion 9 does not need to include a sensor for detecting the position of the lift member 4. It is because the detection means 5 placed in the bill discriminating portion 2 detects a predetermined position of the lift member 4.

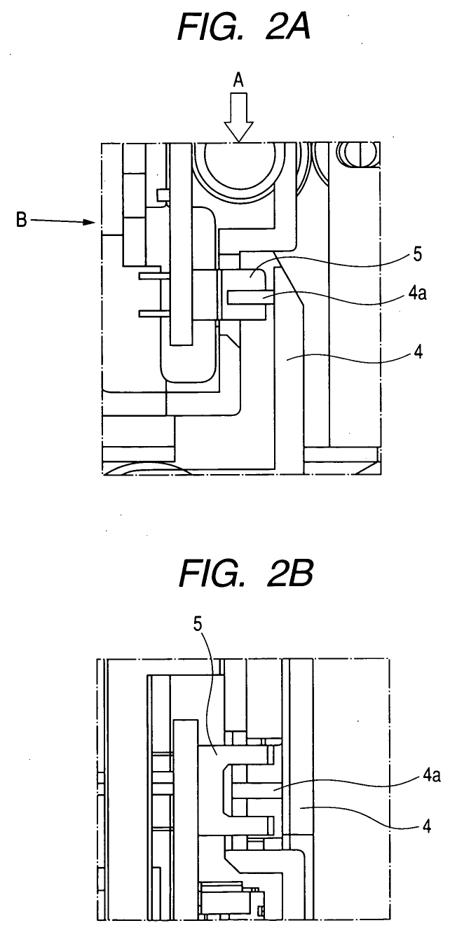

FIG. 2 is an enlarged view of a portion where the detection means 5 and the rib 4a of the lift member 4 are placed close to each other in the state shown in FIG. 1, that is, the state where the bill discriminating portion 2 is mounted to the body 1 of the bill discriminating device and the lift member 4 is placed in the home position. FIG. 2A is an enlarged view of a portion indicated by a reference character B in FIG. 2 when the bill discriminating device is seen from the right side, and FIG. 2B is an enlarged view of the portion seen from the direction of the arrow A in FIG. 2A, that is, downward from an upper side of the bill discriminating device.

The detection means 5 includes a light emitting element and a light receiving element in pair such as light emitting diodes (LEDs) placed to face each other. The light emitting element and the light receiving element are placed to transmit and receive optical signals in a direction parallel to the rotation shaft 12. The lift member 4 has the surface facing the detection means 5 placed in the bill discriminating portion 2, and the surface has the rib 4a protruding from the lift member 4. As shown in FIG. 1, the bill discriminating portion 2 is mounted to the body 1 of the bill discriminating device, and when the lift member 4 is placed in the home position, the rib 4a protruding from the lift member 4 is placed close to the light emitting element and the light receiving element of the detection means 5 therebetween. In this case, light from the light emitting element is blocked by the rib 4a. In this manner, the detection means 5 detects that the lift member 4 is placed in the home position. When the bill discriminating portion 2 is removed from the body 1 of the bill discriminating device with the lift member 4 being placed in the home position, the rib 4a on the lift member 4 is relatively moved from the position between the light emitting element and the light receiving element. In this case, the light having been blocked by the rib 4a is received by the light receiving element. In this manner, the detection means 5 detects that the bill discriminating portion 2 is removed from the body 1 of the bill discriminating device.

Further, in the detection means 5, a first switch portion may include a magnetic sensor such as an induction coil, a Hall element, or a magnetic resistance element. The magnetic sensor is mounted to the bill discriminating portion 2. On the other hand, a second switch portion is appropriately selected in correspondence with the magnetic sensor, and if an induction coil is used, for example, a metal member is selected. For the combination of the induction coil and the metal member, a high frequency current can be passed through the induction coil to use an electromagnetic effect between the induction coil and the metal member close to the induction coil. On the other hand, when the Hall element or the magnetic resistance element is used, a magnetic member such as a magnet is selected. For the combination of the Hall element or the magnetic resistance element and the magnetic member, a magnetic field of the magnetic member such as the magnet close to the Hall element or the magnetic resistance element can be detected and used. When the metal member or the magnetic member is selected, the metal member or the magnetic member is placed on the lift member 4 instead of the rib 4a protruding from the lift member 4.

In the case where the magnetic sensor is used as the detection means 5 as described above, the metal member or the magnetic member and the magnetic sensor are placed closest to each other when the bill discriminating portion 2 is mounted to the body 1 of the bill discriminating device and the lift member 4 is placed in the home position. Thus, when the lift member 4 is placed in the home position, the magnetic sensor can detect the position according to a known principle. On the other hand, when the bill discriminating portion 2 is removed from the body 1 of the bill discriminating device with the lift member 4 being placed in the home position, the magnetic sensor mounted to the bill discriminating portion 2 is moved away from the metal member or the magnetic member placed on the lift member 4, and thus the detection means 5 detects that the bill discriminating portion 2 is removed from the body 1 of the bill discriminating device.

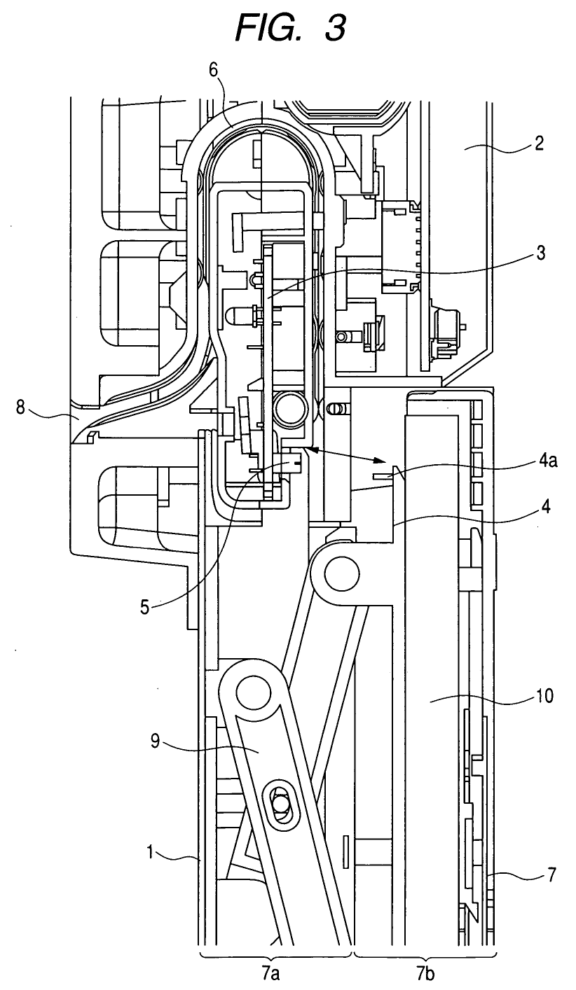

FIG. 3 shows the detection of the lift member 4 in the home position. As described above, the lift member 4 aligns the bundles of bills accommodated in the stacker and presses the bundles toward the back plate 10 so as to be accommodated in the bill accommodating case 7b. In this case, the rib 4a placed between the light emitting element and the light receiving element is moved from the position therebetween in accordance with the movement of the lift member 4. In this case, the light from the light emitting element having been blocked by the rib 4a is received by the light receiving element. Thus, the detection means 5 detects that the lift member is moved from the home position. When the bundles of bills are accumulated, and the lift member 4 returns to the home position again, the light from the light emitting element is blocked by the rib 4a again, and thus the detection means 5 detects that the lift member 4 has returned to the home position again. For example, as described in Japanese Patent Application Laid-Open No. H9-16829, in a bill discriminating device in which a motor is driven to expand and contract a pantograph-shaped member to drive a pressure plate connected to one end of the pantograph-shaped member, a rack that is moved in accordance with the rotation of a shaft of the motor is provided in a bill accommodating portion, and a detection member provided in a bill discriminating portion detects the movement to detect that the pressure plate is in a predetermined position, incomplete engagement between a plurality of gears and part of a pinion prevents alignment between a predetermined position of the rack and a predetermined position of the pressure plate, causing false detection of the position of the pressure plate and such an event that it is determined that the pressure plate is placed in the home position though not in the home position. As described above, in the present invention, the predetermined position of the lift member 4 is detected independently of the rotation of the motor, thereby eliminating such inconvenience.

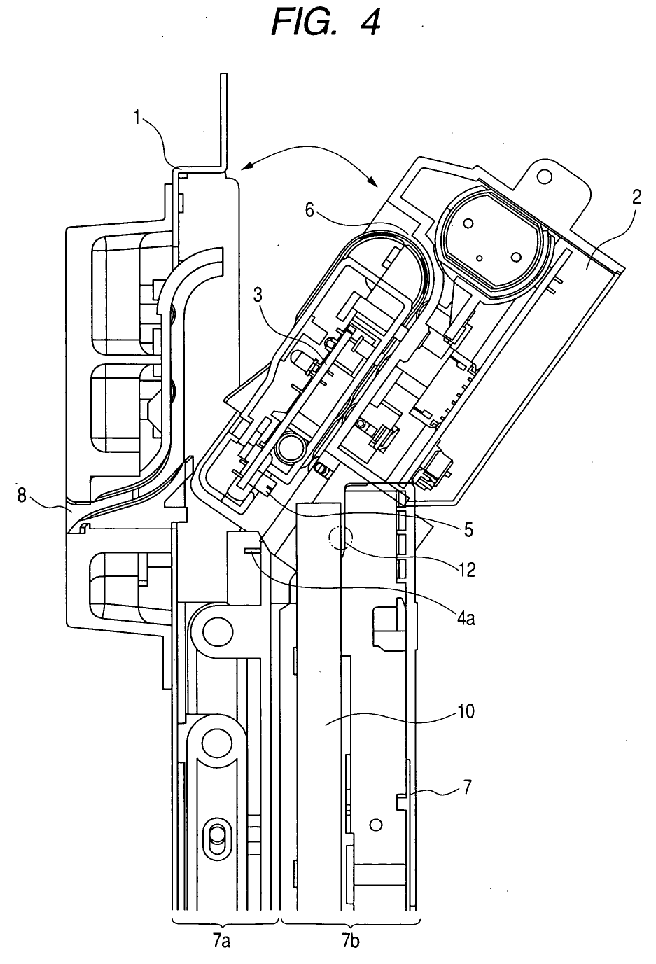

FIG. 4 shows detection of removal when the bill discriminating portion 2 is removed from the body 1 of the bill discriminating device with the lift member 4 being placed in the home position. As described above, when the bill discriminating portion 2 is mounted to the body 1 of the bill discriminating device, and the lift member 4 is placed in the home position, the rib 4a protruding from the lift member 4 is placed between the light emitting element and the light receiving element of the detection means 5. In this state, when the bill discriminating portion 2 is rotated around the rotation shaft 12 and removed from the body 1 of the bill discriminating device as shown in FIG. 4, the detection means 5 mounted to the bill discriminating portion is moved in accordance with the rotation of the bill discriminating portion 2. Thus, the rib 4a of the lift member 4 is relatively moved from the position between the light emitting element and the light receiving element. Then, the light from the light emitting element having been blocked by the rib 4a is received by the light receiving element, and the detection means 5 detects that the bill discriminating portion 2 is removed from the body 1 of the bill discriminating device. The detection is performed at the instant when the blockage of the light is released, that is, the instant when an end of the rib 4a passes through a line connecting the light emitting element and the light receiving element, and thus extremely small rotation of the bill discriminating portion 2 can be detected. As described above, when the bill discriminating portion 2 is left after the maintenance without being completely mounted to the body 1 of the bill discriminating device, the bill discriminating portion 2 enters an adjustment mode for adjusting the range for bill discrimination in order to cancel the influence of exposure of light from the outside of the device even with a slight clearance. Then, when the clearance is closed and the bill discriminating portion 2 is completely mounted after the adjustment, that is, after the bill discriminating portion 2 is adapted to the environment of the exposure of the light, an optimum range is not set to cause inconvenience such as false determination of effectiveness of the bill. For eliminating such inconvenience, when a slight clearance between the bill discriminating portion 2 and the body 1 of the bill discriminating device is detected, it is necessary that the operation of the bill discriminating device is immediately stopped, and the bill discriminating device is not used in such an incomplete state. As described above, in the present invention, the detection that the bill discriminating portion 2 is removed from the body 1 of the bill discriminating device is performed at the instance when the end of the rib 4a passes through the line connecting the light emitting element and the light receiving element, thereby allowing the detection of the extremely small rotation of the bill discriminating portion 2. Also, as described above, the bill discriminating device may be configured so that when the slight clearance between the bill discriminating portion 2 and the body 1 of the bill discriminating device is detected, the operation of the bill discriminating device is immediately stopped.

In the present invention, the detection means 5 only provided in the bill discriminating portion 2 can be used to detect that the lift member 4 that compresses the bundles of bills is placed in the home position in the bill accommodating portion 7, and detect that the bill discriminating portion 2 is removed from the body 1 of the bill discriminating device. Further, with the above described configuration, no detection means needs to be provided in the bill accommodating portion 7, thereby allowing substrates on which electronic components such as the detection means are placed to be collectively placed in the bill discriminating portion 2. The electronic components such as the detection means are sensitive to severe external environment such as the weather and thus need to be sealed, and also from this point of view, the above described configuration is advantageous. The substrates on which the electronic components such as the detection means are placed can be collectively placed in the bill discriminating portion 2, thereby providing a simple production process and significantly reducing production costs.

The above description relates to an embodiment of the present invention, and the gist of the present invention should not be construed as limited to this. In the technical field of the present invention, various modifications could be made by those skilled in the art, and fall within the technical scope of the present invention as long as embodied devices caused by such modifications are equivalent to the present invention.

What is claimed is:

1. A bill discriminating device comprising:
a bill discriminating portion that discriminates inserted bills;
a bill accommodating portion that accommodates bills determined as effective and includes a lift member that aligns and presses said effective bills; and
a body to which said bill discriminating portion and said bill accommodating portion are mounted,
wherein said device further comprises:
a first switch portion mounted to said bill discriminating portion and having an electrical function; and
a second switch portion placed on said lift member and having no electrical function,
said first switch portion and said second switch portion are combined to constitute one switch means when said bill discriminating portion is mounted to said body and said lift member is placed in a predetermined position, and said one switch means generates a first output signal.

2. The bill discriminating device according to claim 1, wherein when said lift member is not placed in the predetermined position with the bill discriminating portion being mounted to the body, or when said bill discriminating portion is removed from said body with said lift member being placed in the predetermined position, said one switch means generates a second output signal.

3. The bill discriminating device according to claim 1, wherein said first output signal is used for detecting that said lift member is placed in the predetermined position.

4. The bill discriminating device according to claim 2, wherein said second output signal is used for detecting that said bill discriminating portion is removed from said body.

5. The bill discriminating device according to claim 1, wherein the first switch portion includes a light emitting element and a light receiving element in pair.

6. The bill discriminating device according to claim 1, wherein the first switch portion includes a magnetic sensor, and said second switch portion includes a metal member or a magnetic member.
